(19) United States
(12) Patent Application Publication
(10) Pub. No.: US 2023/0369739 A1
(43) Pub. Date: Nov. 16, 2023

(54) GLASS PANE, MOTOR VEHICLE AND METHOD

(71) Applicant: Continental Automotive Technologies GmbH, Hannover (DE)

(72) Inventor: Florian Butscher, Aschau im Chiemgau (DE)

(73) Assignee: Continental Automotive Technologies GmbH, Hannover (DE)

(21) Appl. No.: 18/245,297

(22) PCT Filed: Sep. 2, 2021
(86) PCT No.: PCT/DE2021/200118

§ 371 Date: Mar. 14, 2023

(30) Foreign Application Priority Data
Sep. 14, 2020 (DE) 10 2020 211 505.2

(51) Int. Cl. H01Q 1/12; H01Q 3/44; H01Q 1/36

(52) U.S. Cl. CPC H01Q 1/1271; H01Q 3/44; H01Q 1/364

(57) ABSTRACT

A glass pane, in particular glass roof or rear window or side window or windshield, of a motor vehicle, with a pixel matrix arranged in the glass pane, in which pixel matrix at least one antenna structure is producible by means of a rheological material.

The present application is a National Stage Application under 35 U.S.C. § 371 of International Patent Application No. PCT/DE2021/200118 filed on Sep. 2, 2021, and claims priority from German Patent Application No. 10 2020 211 505.2 filed on Sep. 14, 2020, in the German Patent and Trade Mark Office, the disclosures of which are herein incorporated by reference in their entireties.

### BACKGROUND

### 1. Field

Aspects of embodiments of the instant application relate to a glass pane, a motor vehicle comprising a glass pane, and a method of controlling an antenna in a glass pane.

### 2. Description of Related Art

A glass pane, in particular in the form of a glass roof of a motor vehicle, with a pixel matrix arranged in the glass pane, in which pixel matrix an antenna structure is producible by e.g. applying electrical voltage, efficiently enables flexible, adaptive formation and adaptation of antenna structures.

Pixels of such a pixel matrix can be formed by interconnected cells with a rheological material therein, wherein by means of (e.g. electrical, voltage-based or magnetic) control of in each case one of the cells, fluid is movable from the cell into other cells (adjacent cells and/or cells connected via fluid channels) in order to form an antenna structure (by means of the fluid in a plurality of cells and, if appropriate, fluid channels).

Rheological (magnetorheological and/or electrorheological) fluids, in particular electrorheological liquid metals, are known e.g. from:
https://de.wikipedia.org/wiki/Elektrorheologische_FI%/C3%BCssigkeit and
https://de.qwe.wiki/wiki/Electrorheological_fluid and
https://www.ims.kit.edu/1410.php.

Glass panes are known from EP 3 224 901 A1, EP 3 224 442 A1, JP S63 271 320 A, U.S. Pat. No. 2,006,158 715 A1.

Antennas are known from U.S. Pat. No. 2,010,095 762 A1, EP 3 062 390 A1.

### SUMMARY

According to an aspect of an embodiment, a pixel matrix of the glass pane can have cells (in particular arranged next to one another in one or two directions X*Y), wherein cells in the glass pane are each in communication with one or a plurality of in particular adjacent cells via fluid channels, and rheological, in particular electrorheological, fluid, in particular electrorheological liquid metal, is present in the plurality of cells, wherein by means of control of in each case one of the cells, fluid is movable from the cell into other cells in order to form an antenna structure.

According to an aspect of an embodiment, in one, two or more than two edge regions of the glass pane in at least one pixel matrix a respective antenna structure can be producible by applying electrical voltage, wherein (optionally darkened) edge regions of the glass pane (e.g. the regions nearest the edge/outermost regions amounting to maximally 1 or 5 or 10 or 15 percent of the glass pane) are able to be formed with little visual impairment in this way, and wherein antenna diversity can be made possible in the case of optionally two or more antennas.

According to an aspect of an embodiment, in at least two edge regions of the glass pane in the at least one pixel matrix a respective antenna structure can be producible by applying electrical voltage or a magnetic field, and a plurality of antennas and/or at least one antenna extending through a plurality of edge regions can thus be formed.

According to an aspect of an embodiment, in two mutually orthogonal edge regions of the glass pane in the at least one pixel matrix a respective antenna structure can be producible by e.g. applying electrical voltage, and these two antenna structures can be connected up and/or used jointly as an antenna.

An antenna extending over a corner of the glass pane can thus be able to be formed efficiently, for example.

According to an aspect of an embodiment, in at least two opposite corners of the glass pane (i.e. e.g. in two or three or four corners), one of a plurality of antennas can be formed in each case, i.e. the structural space can be utilized efficiently and with spaced apart antennas.

According to an aspect of an embodiment, the glass pane can consist of an e.g. sodium silicate-containing glass or of a plastic.

According to one embodiment of the embodiment, the glass pane can be formed in two layers, in particular with an interspace (e.g. analogously to an LCD display), in which interspace at least one electro- or magnetorheological pixel matrix can be arranged, by means of which antenna structures are able to be formed.

The pixel matrix can thus be protected efficiently against external mechanical influences.

According to one embodiment of the embodiment, in the at least one pixel matrix in each case at least one antenna structure can be producible by applying an electrical voltage and/or applying a magnetic field to one or a plurality of cells.

### BRIEF DESCRIPTION OF THE DRAWINGS

Further features and advantages of some embodiments will become apparent from the following description with reference to the drawings, in which:

FIG. 1 shows in longitudinal sectional view a motor vehicle comprising a roof window with antenna structures;

FIG. 2 shows in plan view a glass roof of a motor vehicle with antenna structures producible in each case by at least one pixel matrix;

FIG. 3 shows in plan view a glass roof of a motor vehicle with antenna structures and antennas in the glass roof, which are produced by a pixel matrix and are represented symbolically as lines; and

FIG. 4 shows in longitudinal sectional view a glass roof of a motor vehicle with antenna structures producible by a pixel matrix in the glass roof and their electrical linking by a wiring harness.

### DETAILED DESCRIPTION

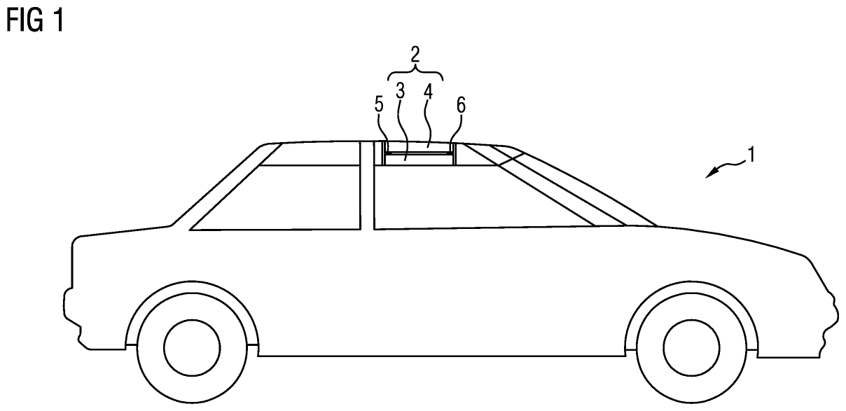

FIG. 1 shows a motor vehicle 1 with one exemplary embodiment of a glass pane 2 (here in the form of a glass roof) according to the embodiment, here composed of two (alternatively one or more than two) panes 3, 4 with here more than one pixel matrix 5, 6, (7, 8) composed of optionally in each case very many (magneto- or electro)rheological cells (10-20), the interconnection of which makes it possible to form at least one antenna structure (90, 91, 92, 93) for forming at least one antenna (100 or 101).

Just like a glass pane 2 according to the embodiment in the form of a glass roof, provision can also be made of a glass pane in the form of a sliding roof and/or a rear window and/or a side window and/or a windshield with (in each case) at least one pixel matrix 5, 6, 7, 8 composed of optionally very many (magneto- or electro)rheological cells 10-20 in the motor vehicle 1.

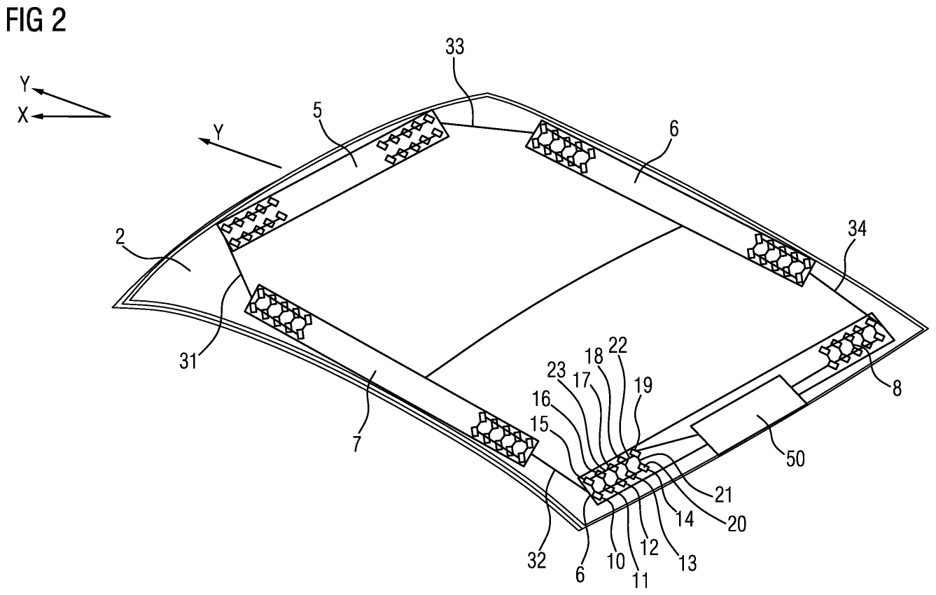

FIG. 2 shows, in a plan view of a roof of a motor vehicle 1, a glass pane 2 in the form of e.g. a glass roof (which e.g. as here can be formed as a sliding roof and can be displaceable in direction y) with antenna structures (90) producible in each case by a pixel matrix 5, 6, 7, 8 composed in each case of cells 10-19. A pixel matrix 5, 6, 7, 8 can have in each case a plurality of cells 10-19 (also many more than illustrated here), each of which can be filled with a rheological fluid 20 or empty, wherein the rheological fluid 20 (indicated as a dot in a cell) can be moved from one cell 10-19 into another of the cells 10-19 by applying a voltage or a magnetic field in the region of the cell (in a manner known per se).

Cells 10-19 of a pixel matrix 5, 6, 7, 8 can be arranged e.g. in one or two or more rows (here in the x/y directions, optionally also in the z direction) and/or next to one another.

The fluid 20 can be e.g. a rheological liquid metal.

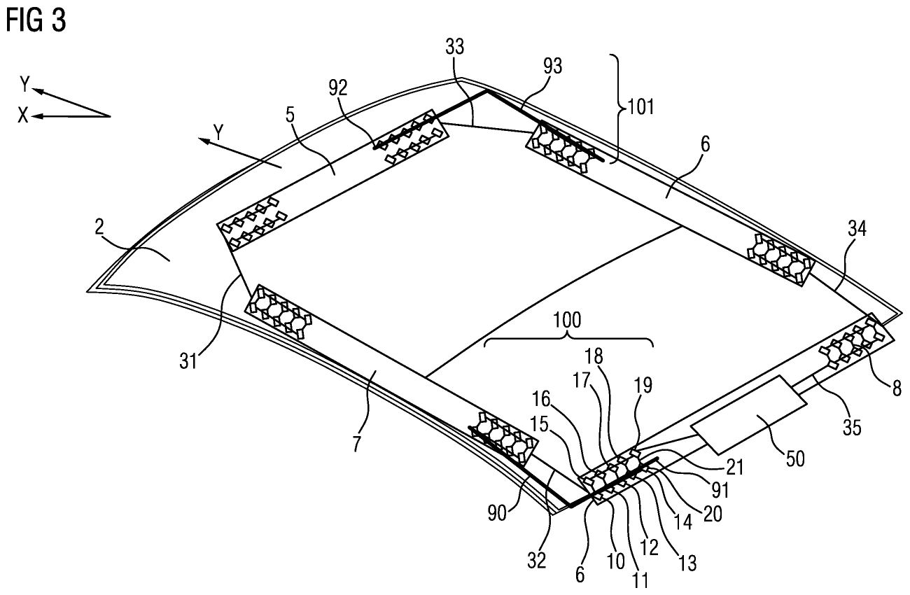

When the fluid 20 is situated e.g. in the cells 10, 11, 12, 13, 14 (and optionally also in the channels 21, 22, 23, etc. therebetween), it can form e.g. a linear antenna structure 90 (or likewise 91, 92, 93) (indicated by a respective bar in FIG. 3).

Each antenna structure 90, 91, 92, 93 can be used as an antenna 100, 101, or e.g. (in each case) two antenna structures 90, 91 (and/or 92, 93) can be connected to one another via connections 31, 32, 33, 34 and thus together form an antenna 100, 101. Each antenna 100, 101 can be connected to the controller or the connectivity module 50 and can be used e.g. for receiving and/or transmitting signals for e.g. /3G/4G/5G/6G mobile radio and/or WiFi and/or NFC and/or RKE, DAB and/or GPS/Glossnass/Galileo, etc.

Each pixel matrix 5, 6, 7, 8 can be connected via a connection to exactly one further pixel matrix 5, 6, 7, 8 or to a plurality of pixel matrices 5, 6, 7, 8 by means of a respective electrically conductive connection (e.g. wires) 31, 32, 33, 34.

The pixel matrix or pixel matrices 5, 6, 7, 8 can each be connected (for the purpose of connecting the antenna regions 90, 91, 92, 93 formed thereby) to a connectivity module 50 (e.g. for transmitting/receiving for 2G/3G/4G/5G/6G mobile radio and/or WiFi and/or NFC and/or RKE, DAB and/or GPS/Glossnass/Galileo, etc. and/or to an ECU), which can be connected via a radio link and/or a cable link to a further controller and/or at least one bus system of the motor vehicle 1.

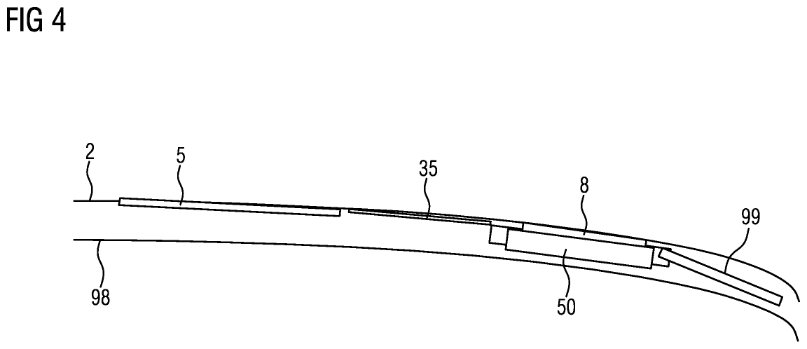

FIG. 4 shows in longitudinal sectional view a glass roof 2 of a motor vehicle, the motor vehicle headliner 98 with antenna structures producible by a respective pixel matrix 5, (6, 7,) 8 in the glass roof 2 and their (5-8, 90-93) electrical link 35 (for transmitting and/or receiving and/or in each case for controlling the rheological cells) to a (connectivity) module 50, and the link thereof to a motor vehicle network by a wiring harness 99.

Applying a regulable voltage from the ECU of the connectivity module 50 to rheological cells in the glass makes it possible to activate defined regions and to produce specific antenna structures in the smart glass. These antenna structures can then cover specific frequency ranges for the required services such as e.g. telephone, WiFi, RKE, DAB, etc.

Voltage regulation/control from the ECU of the connectivity module 50 likewise enables antenna structures that have already been defined differently to be activated, and these then serve once again for further services at other frequencies. A received signal can be processed in the connectivity module and passed on to the infrastructure of the vehicle.

Regions in which specific antennas are produced by way of voltage regulation/control from the ECU can be situated at the edge of the glass roof e.g. in the vicinity of the adhesive bonding joints to the vehicle structure. The view through the glass roof thus remains unrestricted for occupants.

1. A glass pane comprising:
a matrix arranged in the glass pane, the pixel matrix comprising:
a plurality of interconnected cells,
a plurality of fluid channels interconnecting the plurality of interconnected cells, and a rheological material disposed in at least one cell among the plurality of interconnected cells configured to form an antenna.

2. The glass pane as claimed in claim 1, wherein the rheological material comprises magneto- and/or electrorheological.

3. The glass pane- as claimed in claim 2, wherein the matrix is disposed in at least one edge region of the glass pane.

4. The glass pane as claimed in claim 2, wherein the matrix is disposed in two mutually orthogonal edge regions of the glass pane, and
wherein the antenna comprises two antenna structures connected to each other.

5. The glass pane as claimed in claim 2, wherein the matrix is disposed in two opposite corners of the glass pane, and
wherein the antenna comprises a first antenna disposed in a first corner among the two opposite corners and a second antenna disposed in a second corner among the two opposite corners.

6. The glass pane as claimed in claim 2, further comprising a darkened edge region of the glass pane,
wherein the antenna is arranged in the darkened edge region of the glass pane.

7. The glass pane as claimed in claim 2, wherein the glass pane is formed of a glass or formed of a plastic.

8. The glass pane as claimed in claim 2, further comprising an interspace, wherein the matrix is formed within the interspace.

9-10. (canceled)

11. An antenna control system comprising:
a glass plane;
a matrix arranged in the glass pane, the pixel matrix comprising:
a plurality of interconnected cells,
a plurality of fluid channels interconnecting the plurality of interconnected cells, and
a rheological material disposed in at least one cell among the plurality of interconnected cells configured to form an antenna; and
an electronic control unit (ECU) configured to apply a voltage or a magnetic field to the glass plane, the voltage or the magnetic field configured to control the rheological material to be disposed in the at least one cell to form the antenna.
